(19) United States
(12) Patent Application Publication
(10) Pub. No.: US 2018/0155058 A1
(43) Pub. Date: Jun. 7, 2018

(54) AUTONOMOUS VEHICLE WITH SECONDARY CAMERA SYSTEM FOR USE WITH ENCOUNTERED EVENTS DURING TRAVEL

(71) Applicant: Wal-Mart Stores, Inc., Bentonville, AR (US)

(72) Inventors: Timothy M. Fenton, Bentonville, AR (US); Donald R. High, Noel, MO (US)

(21) Appl. No.: 15/829,648

(22) Filed: Dec. 1, 2017

Related U.S. Application Data
(60) Provisional application No. 62/428,929, filed on Dec. 1, 2016.

(51) Int. Cl. B64D 47/08; G08G 5/00; B64C 39/02; H04N 7/18; G06K 9/00

(52) U.S. Cl. CPC B64D 47/08; G08G 5/0086; B64C 39/024; G08G 5/0069; B64C 2201/141; G06K 9/0063; B64C 2201/127; B64C 2201/146; H04N 7/181

(57) ABSTRACT

In some embodiments, apparatuses and methods are provided herein useful to monitoring an event encountered by an autonomous vehicle. In some embodiments, an autonomous vehicle for monitoring an encountered event comprises a vehicle body, a propulsion mechanism, a plurality of sensors configured to detect travel information, a primary camera system affixed to the vehicle body, a secondary camera system including two or more cameras, wherein each of the two or more camera has a different fixed field of view, and wherein each of the two or more cameras are affixed to different portions of the vehicle body, and a control circuit, the control circuit configured to receive, from the plurality of sensors, the travel information, determine, based on the travel information, that a trigger condition has occurred, and in response to a determination that the trigger condition has occurred, cause video captured by the secondary camera system to be stored.

### CROSS-REFERENCE TO RELATED APPLICATION

This application claims the benefit of U.S. Provisional Application No. 62/428,929, filed Dec. 1, 2016, which is incorporated by reference in its entirety herein.

### TECHNICAL FIELD

This invention relates generally to autonomous vehicles and, more particularly, autonomous vehicles with secondary camera systems.

### BACKGROUND

Autonomous vehicles, such as drones, are becoming more common. As the number of autonomous vehicles increases, so does the risk that an autonomous vehicle will crash and cause damage and/or injury. In the event of a crash, understanding the action of the autonomous vehicles, the autonomous vehicle's surroundings, and other events near and/or related to the autonomous vehicle can help determine the cause of the crash. Many autonomous vehicles have a primary camera system. However, the primary camera system is used for photographic and/or navigational purposes and does not provide a complete view of the autonomous vehicle's surroundings. Consequently, a need exists for an autonomous vehicle that has the capability to capture its surroundings.

### BRIEF DESCRIPTION OF THE DRAWINGS

Disclosed herein are embodiments of systems, apparatuses, and methods pertaining to an autonomous vehicle including a secondary camera system for detecting events encountered by the autonomous vehicle. This description includes drawings, wherein:

FIGS. 1A and 1B depict an autonomous vehicle 100 including a secondary camera system 104, according to some embodiments;

FIG. 2 is a block diagram of autonomous vehicle 202 including a secondary camera system 212, according to some embodiments;

FIG. 3 is a flow chart including example operations for monitoring an event encountered by an autonomous vehicle, according to some embodiments; and

FIG. 4 depicts a quadcopter-style autonomous vehicle 400 including a secondary camera system, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to monitoring an event encountered by an autonomous vehicle. In some embodiments, an autonomous vehicle for monitoring an encountered event comprises a vehicle body, a propulsion mechanism configured to self-propel the autonomous vehicle at least one of self-controlled and remote controlled, a plurality of sensors configured to detect travel information for the autonomous vehicle, a primary camera system for one or more of photographic purposes and navigational purposes, wherein the primary camera system is affixed to the vehicle body, a secondary camera system, wherein the secondary camera system includes two or more cameras, wherein each of the two or more camera has a different fixed field of view, and wherein each of the two or more cameras are affixed to different portions of an exterior of the vehicle body, and a control circuit communicatively coupled to the plurality of sensors and the secondary camera system, the control circuit configured to receive, from the plurality of sensors, the travel information for the autonomous vehicle, determine, based on the travel information for the autonomous vehicle, that a trigger condition has occurred, the trigger condition indicative of a potential crash condition of the autonomous vehicle, and in response to a determination that the trigger condition has occurred, cause video captured by the secondary camera system to be stored.

As previously discussed, autonomous vehicles are becoming more common and, as a result, the occurrence of autonomous vehicle crashes is increasing. An autonomous vehicle crash can cause damage to the autonomous vehicle, damage to property, and injury to people and/or animals near the autonomous vehicle. Consequently, operators of autonomous vehicles seek to minimize the risk of a crash.

Determining the cause of a crash can be helpful in preventing future crashes from occurring. For example, information obtained from a crash can be used to modify the autonomous vehicle as well as the software that controls the autonomous vehicle. The greater the quantity of information obtained, the more likely it is that a cause of the crash can be determined. Embodiments of the inventive subject matter seek to provide as much information as possible about a crash. For example, described herein is an autonomous vehicle that includes a plurality of sensors to detect travel information for the autonomous vehicle and a secondary camera system. The secondary camera system includes multiple cameras having different fields of view. When configured in such a manner, the secondary camera system can capture and/or record the autonomous vehicle's surroundings, providing valuable information in determining the cause of a crash.

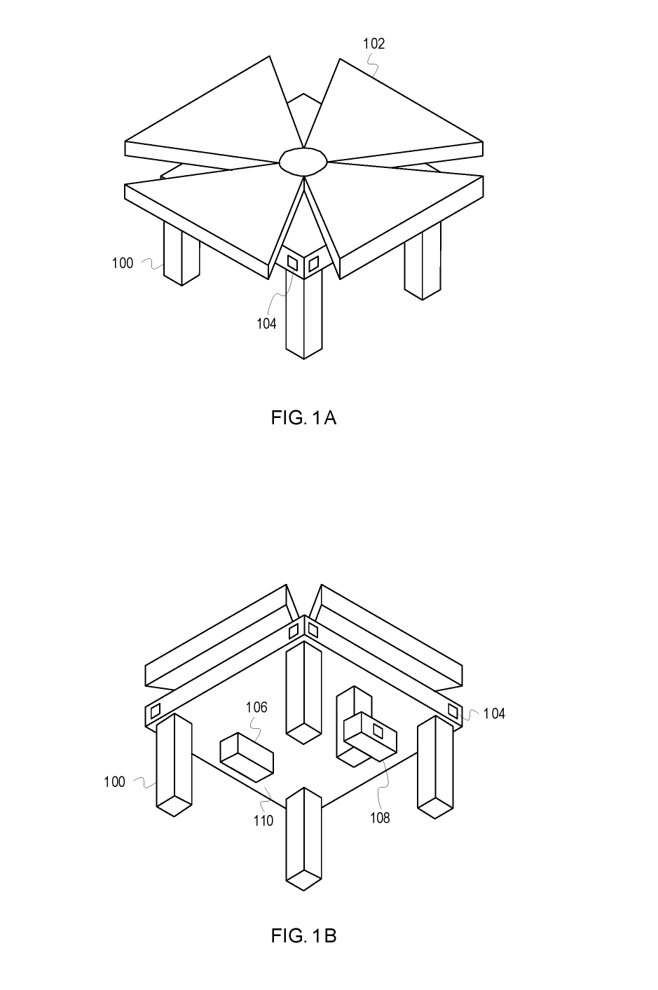

FIGS. 1A and 1B depict an autonomous vehicle 100 including a secondary camera system 104, according to some embodiments. The autonomous vehicle 100 depicted in FIGS. 1A and 1B is an aerial vehicle. Although the autonomous vehicle depicted in FIGS. 1A and 1B is an aerial vehicle, the details described herein can be used with other types of autonomous vehicles, such as terrestrial autonomous vehicles and aquatic autonomous vehicles.

The autonomous vehicle 100 depicted in FIGS. 1A and 1B includes a vehicle body 110. Affixed to the vehicle body 110 is a propulsion mechanism 102, sensors 106, and a primary camera system 108. The propulsion mechanism 102 provides force to move the autonomous vehicle 100. In the example autonomous vehicle 100 depicted in FIGS. 1A and 1B, the propulsion mechanism 102 is a rotary system including a propeller and a motor. The sensors 106 can be affixed anywhere on the autonomous vehicle 100 and can be any suitable type of sensor. For example, the sensors 106 can include radar sensors, temperature sensors, time sensors (e.g., a clock), power sensors, sound sensors, reservoir level sensors, weight sensors, location sensors (e.g., GPS transceivers), altitude sensors (e.g., altimeters), gyroscopes, pressure sensors, humidity sensors, moisture sensors, accelerometers, etc. The sensors 106 can be used for navigational purposes and/or crash determination purposes. For example, the sensors 106 detect travel information for the autonomous vehicle 100, such as the autonomous vehicle's 100 direction of travel, the autonomous vehicle's 100 speed, the autonomous vehicle's 100 altitude, weather conditions, the presence of objects near the autonomous vehicle 100, electromagnetic energy (e.g., radiofrequency signals) near the autonomous vehicle 100, etc. The primary camera system 108 can include a still camera and/or a video camera and is used for photographic and/or navigational purposes. The camera of the primary camera system 108 can be fixed or movable (e.g., controlled by the autonomous vehicle 100 or an operator of the autonomous vehicle 100). In one embodiment, the camera of the primary camera system 108 is a high resolution camera and the images and/or video captured by the primary camera system 108 are streamed and/or recorded.

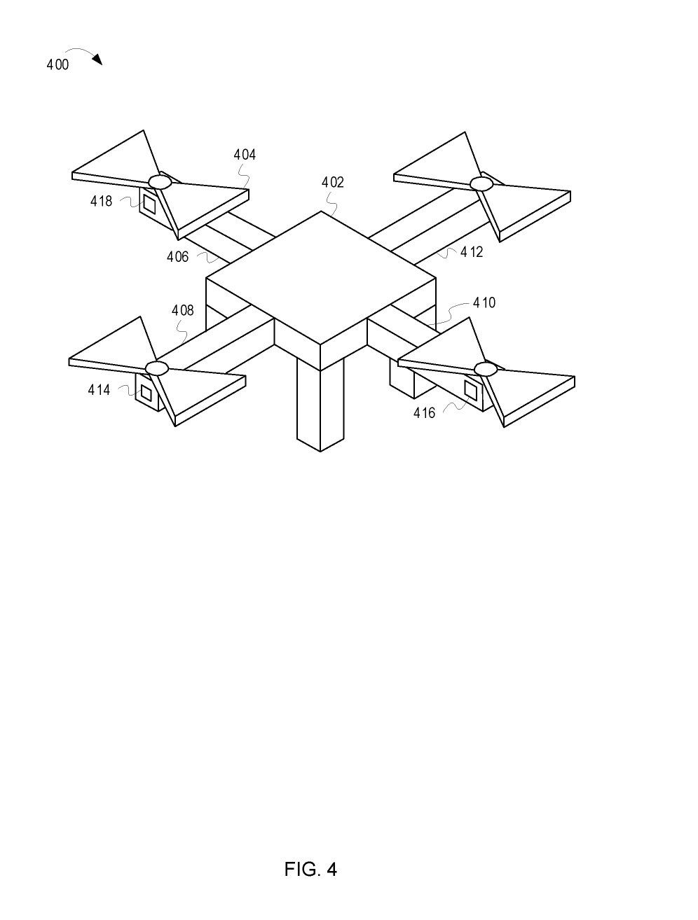

Additionally, the autonomous vehicle 100 includes a secondary camera system 104, the cameras of which are affixed to the vehicle body 110. The secondary camera system 104 includes multiple cameras positioned about the autonomous vehicle 100 and affixed to an exterior surface of the autonomous vehicle 110. In some embodiments, the cameras of the secondary camera system 104 are positioned in such a manner that each of the cameras has a different field of view (i.e., the cameras do not have substantially overlapping fields of view). Preferably, the secondary camera system 104 is capable of capturing a three hundred sixty degree view about the autonomous vehicle 100. As one example, if the autonomous vehicle is a quadcopter (i.e., an autonomous vehicle having four arms, each arm including a propeller, such as the autonomous vehicle depicted in FIG. 4), the cameras of the secondary camera system 104 can be mounted on each of the four arms (e.g., one on each arm, two on each arm, etc.). The cameras of the secondary camera system 104 can be still cameras or video cameras. Additionally, the cameras of the secondary camera system 104 can, but do not need to, be high resolution cameras. In some embodiments, the cameras of the secondary camera system 104 can be small, low resolution cameras in an effort to minimize the weight, power requirements, and data storage requirements of the secondary camera system 104.

While the secondary camera system 104 can record and store images and/or video during the entirety of the autonomous vehicle's 100 journey, in some embodiments, the secondary camera system 104 only records and/or stored images and/or video when a potential crash condition is detected. For example, the autonomous vehicle 100 can detect a potential crash condition based on the occurrence of a trigger condition. The trigger condition can be any behavior or observation of a potential crash condition. For example, the trigger condition can be an impact or deceleration, a deviation from a planned path (e.g., a flight plan), instability of the autonomous vehicle, a sound, etc. The trigger condition can occur before, during, or after a crash. For example, if the trigger condition is a sudden deceleration of the autonomous vehicle, the trigger condition likely occurred during the crash. However, if the trigger condition is a sudden drop in altitude, the trigger condition likely occurred before the crash.

Upon detection of the trigger condition, the autonomous vehicle 100 stores video captured by the secondary camera system 104 (i.e., secondary video). The secondary video can comprise video and or still images. In embodiments in which the secondary camera system 104 continually captures video during the duration of the journey, the detection of the trigger condition will cause the secondary video to be stored. In embodiments in which the secondary camera system does not continually capture video during the duration of the journey, detection of the trigger condition will cause the secondary camera system 104 to capture video. The secondary video can be stored locally (e.g., on a memory device of the autonomous vehicle 100) and/or remotely (e.g., the autonomous vehicle 100 can stream the video to a server for storage). Additionally, in some embodiments, upon detection of the trigger condition, the autonomous vehicle 100 can also store the travel information detected by the sensors 106. As with the secondary video, the travel information can be stored locally and/or remotely.

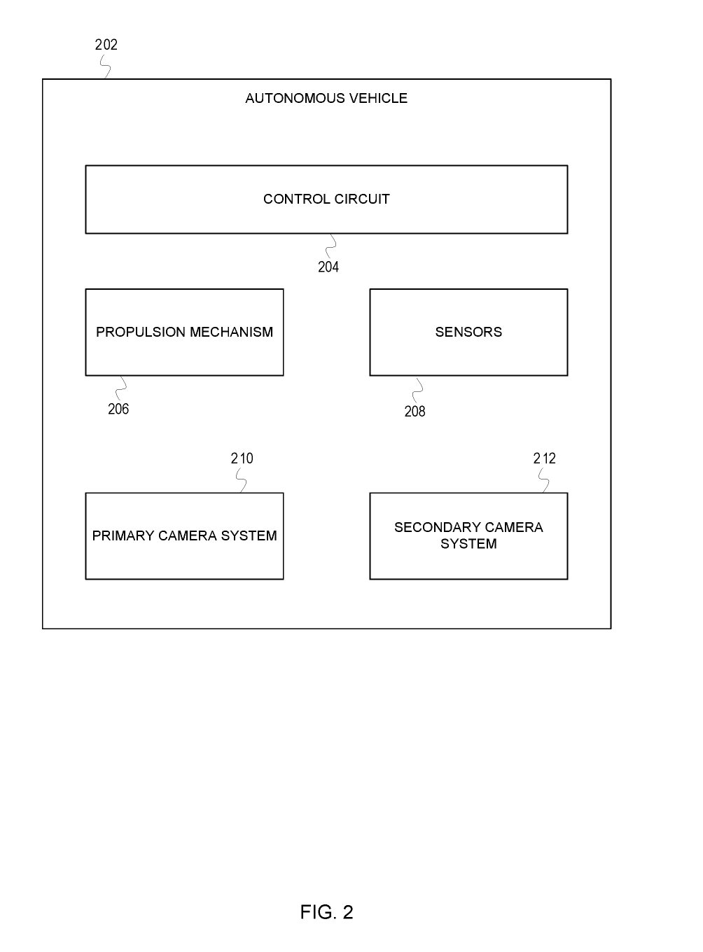

While the discussion of FIGS. 1A and 1B provides an overview of an example autonomous vehicle including a secondary camera system, the discussion of FIG. 2 provides additional information regarding an autonomous vehicle including a secondary camera system.

FIG. 2 is a block diagram of autonomous vehicle 202 including a secondary camera system 212, according to some embodiments. The autonomous vehicle 202 includes a control circuit 204, a propulsion mechanism 206, sensors 208, a primary camera system 210, and a secondary camera system 212.

The control circuit 204 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 204 is configured (for example, by using corresponding programming as will be well understood by those skilled in the art) to carry out one or more of the steps, actions, and/or functions described herein.

By one optional approach the control circuit 204 operably couples to a memory. The memory may be integral to the control circuit 204 or can be physically discrete (in whole or in part) from the control circuit 204 as desired. This memory can also be local with respect to the control circuit 204 (where, for example, both share a common circuit board, chassis, power supply, and/or housing) or can be partially or wholly remote with respect to the control circuit 204 (where, for example, the memory is physically located in another facility, metropolitan area, or even country as compared to the control circuit 204).

This memory can serve, for example, to non-transitorily store the computer instructions that, when executed by the control circuit 204, cause the control circuit 204 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The propulsion mechanism 206 propels the autonomous vehicle 202. The propulsion mechanism 206 can be of any suitable type dependent upon the type of the autonomous vehicle 202. For example, the propulsion mechanism 206 for an aerial autonomous vehicle may include one or more propellers and one or more motors, whereas the propulsion mechanism 206 for a terrestrial autonomous vehicle may include an engine or motor and transmission.

The sensors 208 detect travel information for the autonomous vehicle 202. The travel information can include the autonomous vehicle's 202 direction of travel, the autonomous vehicle's 202 speed, the autonomous vehicle's 202 altitude, weather conditions, the presence of objects near the autonomous vehicle 202, electromagnetic energy (e.g., radiofrequency signals) near the autonomous vehicle 202, etc. Accordingly, the sensors 208 can be any type of sensor that is suitable to detect the travel information. For example, the sensors can include radar sensors, temperature sensors, time sensors (e.g., a clock), power sensors, sound sensors, reservoir level sensors, weight sensors, location sensors (e.g., GPS transceivers), altitude sensors (e.g., altimeters), gyroscopes, pressure sensors, humidity sensors, moisture sensors, accelerometers, etc. The travel information can be used for navigational purposes. Additionally, in some embodiments, the travel information can be stored and used to aid in determining a cause of a crash.

The primary camera system 210 is affixed to the autonomous vehicle 202 and can capture still images and/or video. Typically, the primary camera system 210 includes a high resolution camera. The primary camera system 210 is used for photographic and/or navigational purposes.

The secondary camera system 212 includes two or more cameras that are affixed to the autonomous vehicle 202. Each of the two or more cameras can include a set of cameras (e.g., each of the two or more cameras includes a set of two cameras). In some embodiments, the secondary camera system 212 is independent of the primary camera system 210. The cameras of the secondary camera system 212 are positioned about the autonomous vehicle 202 such that the combined field of view of the cameras is large. For example, the cameras can be positioned about the autonomous vehicle 202 to capture a one hundred eighty degree, two hundred seventy degree view, or three hundred sixty degree view about the autonomous vehicle 202. The cameras of the secondary camera system 212 can also be positioned so that their field of view extends about the autonomous vehicle 202 in both a horizontal plane as well as a vertical plane. Additionally, the orientation of the cameras of the secondary camera system 212 can be fixed, or the cameras can be movable (or a combination of both).

When a trigger condition is detected, the control circuit 204 causes video captured by the secondary camera system 212 to be stored. For example, the control circuit 204 can cause the video captured by the secondary camera system 212 to be saved (e.g., not deleting a camera buffer) and/or cause the secondary camera system to begin capturing video. The control circuit 204 can cause any suitable amount of video to be stored. For example, the control circuit 204 can cause the last several minutes (if available) before the occurrence of the trigger condition or the last several seconds (e.g., thirty seconds). Additionally, the control circuit 204 can cause video captured after the trigger condition (and crash, if any) occurs to be stored. Again, any suitable amount of video can be stored, such as several second or several minutes. In some embodiments, upon occurrence of the trigger condition, the control circuit 204 can also cause the travel information to be stored. As with the video, the control circuit 204 can cause any suitable amount of travel information to be stored (e.g., several seconds, several minutes, several hours, etc.). The video and/or travel information can be stored locally by the autonomous vehicle 202 or remotely.

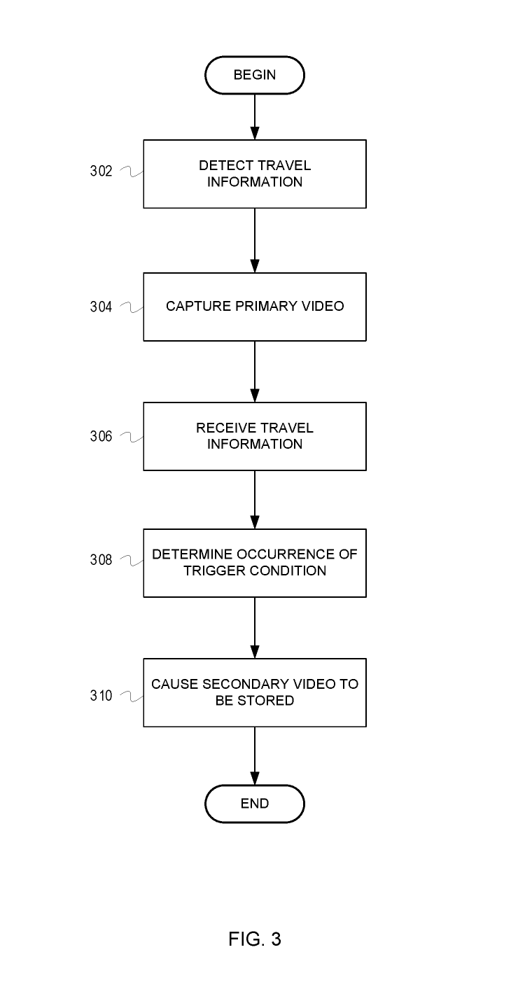

While the discussion of FIG. 2 provides additional information regarding an autonomous vehicle having a secondary camera system, the discussion of FIG. 3 describes example operations for monitoring an event encountered by an autonomous vehicle and causing video captured by the secondary camera system to be stored.

FIG. 3 is a flow chart including example operations for monitoring an event encountered by an autonomous vehicle, according to some embodiments. The flow begins at block 302.

At block 302, travel information for the autonomous vehicle is detected. For example, sensors associated with the autonomous vehicle can detect the travel information for the autonomous vehicle. The travel information can include the autonomous vehicle's direction of travel, the autonomous vehicle's speed, the autonomous vehicle's altitude, weather conditions, the presence of objects near the autonomous vehicle, electromagnetic energy (e.g., radiofrequency signals) near the autonomous vehicle, etc. Accordingly, the sensors can be any type of sensor that is suitable to detect the travel information. For example, the sensors can include radar sensors, temperature sensors, time sensors (e.g., a clock), power sensors, sound sensors, reservoir level sensors, weight sensors, location sensors (e.g., GPS transceivers), altitude sensors (e.g., altimeters), gyroscopes, pressure sensors, humidity sensors, moisture sensors, accelerometers, etc. The flow continues at block 304.

At block 304, primary video is captured. For example, the primary video is captured by a primary camera system. The primary video is used for photographic and/or navigational purposes. The primary camera system is affixed to the autonomous vehicle. The flow continues at block 306.

At block 306, travel information is received. For example, the travel information can be received by a control circuit from the sensors. The flow continues at block 308.

At block 308, occurrence of trigger condition is determined. For example, the control circuit can determine the occurrence of the trigger condition based on the travel information. The trigger condition is indicative of a potential crash condition. For example, the trigger condition can be an impact or deceleration, a deviation from a planned path, instability of the autonomous vehicle, a sound, etc. The trigger condition can occur before, during, or after a crash. The flow continues at block 310.

At block 310, secondary video is caused to be stored. For example, the control circuit can cause the secondary video to be stored. The secondary video is video captured by the secondary camera system. The control circuit can cause the secondary video to be stored locally or remotely. Additionally, in some embodiments, the control circuit can cause the travel information to be stored. If the secondary video captured information relevant to a crash or action that almost resulted in a crash, the secondary video may be useful in determining a cause of the crash or a cause of the action that almost resulted in a crash.

FIG. 4 depicts a quadcopter-style autonomous vehicle 400 including a secondary camera system, according to some embodiments. The autonomous vehicle 400 depicted in FIG. 4 is similar to the autonomous vehicle described with reference to FIG. 1 in that the autonomous vehicle 400 includes a plurality of sensors to detect travel information for the autonomous vehicle 400 and a secondary camera system. The data collected by the plurality of sensors and the secondary camera system can be used to aid in determining a cause of a crash.

As the autonomous vehicle 400 is a quadcopter-style autonomous vehicle 400, it includes a vehicle body 402 and four arms (a first arm 406, a second arm 408, a third arm 410, and a fourth arm 412) affixed to the vehicle body 402. Each of the arms includes a rotor 404. The autonomous vehicle 400 also includes a secondary camera system. The secondary camera system includes cameras on each of the four arms. In the example depicted in FIG. 4, each arm includes three cameras: a first camera directed away from the vehicle body 402 (e.g., the second arm camera 414), a second camera located on a surface to the left and adjacent to the surface on which the first camera is mounted (e.g., the first arm camera 418), and a third camera that is mounted opposite the second camera (e.g., the third arm camera 416). While such a configuration (i.e., three cameras on each arm) can provide a nearly complete view of the area around the autonomous vehicle 400, a similar, if not identical, view can be achieved with the use of a greater or lesser number of cameras. It is understood that while a quadcopter configuration is illustrated, any number of rotors 404 could be utilized. Additionally, bumpers or other structures may be included that surround the sides of one or more of the rotors 404 to protect them from damage due to unintentional contact. In some embodiments, individual cameras may be variously located about these bumpers at different locations each providing a view from the different location such that these views can be viewed together to get a nearly complete view around the autonomous vehicle 400.

In some embodiments, an autonomous vehicle for monitoring an encountered event comprises a vehicle body, a propulsion mechanism configured to self-propel the autonomous vehicle at least one of self-controlled and remote controlled, a plurality of sensors configured to detect travel information for the autonomous vehicle, a primary camera system for one or more of photographic purposes and navigational purposes, wherein the primary camera system is affixed to the vehicle body, a secondary camera system, wherein the secondary camera system includes two or more cameras, wherein each of the two or more camera has a different fixed field of view, and wherein each of the two or more cameras are affixed to different portions of an exterior of the vehicle body, and a control circuit communicatively coupled to the plurality of sensors and the secondary camera system, the control circuit configured to receive, from the plurality of sensors, the travel information for the autonomous vehicle, determine, based on the travel information for the autonomous vehicle, that a trigger condition has occurred, the trigger condition indicative of a potential crash condition of the autonomous vehicle, and in response to a determination that the trigger condition has occurred, cause video captured by the secondary camera system to be stored.

In some embodiments, an apparatus, and a corresponding method performed by the apparatus, comprises detecting, by a plurality of sensors, travel information for the autonomous vehicle, capturing, by a primary camera system, primary video for one or more of photographic purposes and navigational purposes, wherein the primary camera system is affixed to a vehicle body of the autonomous vehicle, receiving, from the plurality of sensors, the travel information for the autonomous vehicle, determining, based on the travel information for the autonomous vehicle, that a trigger condition has occurred, wherein the trigger condition is indicative of a potential crash condition for the autonomous vehicle, and in response to determining that the trigger condition has occurred, causing video captured by a secondary camera system to be stored, wherein the secondary camera system includes two or more cameras, wherein each of the two or more cameras has a different fixed field of view, and wherein the two or more cameras are affixed to different portions of the vehicle body of the autonomous vehicle.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. An autonomous vehicle for monitoring an encountered event encountered, the autonomous vehicle comprising:
a vehicle body;
a propulsion mechanism configured to self-propel the autonomous vehicle at least one of self-controlled and remote controlled;
a plurality of sensors configured to detect travel information for the autonomous vehicle;
a primary camera system for one or more of photographic purposes and navigational purposes, wherein the primary camera system is affixed to the vehicle body;
a secondary camera system, wherein the secondary camera system includes two or more cameras, wherein each of the two or more cameras has a different fixed field of view, and wherein each of the two or more cameras are affixed to different portions of an exterior surface of the vehicle body; and
a control circuit communicatively coupled to the plurality of sensors and the secondary camera system, the control circuit configured to:
receive, from the plurality of sensors, the travel information for the autonomous vehicle;
determine, based on the travel information for the autonomous vehicle, that a trigger condition has occurred, the trigger condition indicative of a potential crash condition of the autonomous vehicle; and
in response to a determination that the trigger condition has occurred, cause video captured by the secondary camera system to be stored.

2. The autonomous vehicle of claim 1, wherein the primary camera system is independent from the secondary camera system.

3. The autonomous vehicle of claim 1, wherein the two or more cameras have a three hundred sixty degree view about the autonomous vehicle.

4. The autonomous vehicle of claim 1, wherein each of the two or more cameras comprises a set of cameras.

5. The autonomous vehicle of claim 1, wherein the control circuit causes the video captured by the secondary camera system to be stored comprises not deleting a camera buffer.

6. The autonomous vehicle of claim 1, wherein the trigger condition is an impact event.

7. The autonomous vehicle of claim 1, wherein the control circuit causes the video captured by the secondary camera system to be stored comprises causing the secondary camera system to begin capturing the video.

8. The autonomous vehicle of claim 1, wherein autonomous vehicle is an aerial vehicle, and wherein the trigger condition is a deviation from a flight plan.

9. The autonomous vehicle of claim 1, wherein the vehicle body includes four arms, wherein the secondary camera system includes four cameras, and wherein each of the four arms includes one of the four cameras.

10. A method for monitoring an event encountered by an autonomous vehicle, the method comprising:
detecting, by a plurality of sensors, travel information for the autonomous vehicle;
capturing, by a primary camera system, primary video for one or more of photographic purposes and navigational purposes, wherein the primary camera system is affixed to a vehicle body of the autonomous vehicle;
receiving, from the plurality of sensors, the travel information for the autonomous vehicle;
determining, based on the travel information for the autonomous vehicle, that a trigger condition has occurred, wherein the trigger condition is indicative of a potential crash condition of the autonomous vehicle; and
in response to determining that the trigger condition has occurred, causing video captured by a secondary camera system to be stored, wherein the secondary camera system includes two or more cameras, wherein each of the two or more cameras has a different fixed field of view, and wherein the two or more cameras are affixed to different portions of the vehicle body of the autonomous vehicle.

11. The method of claim 10, wherein the primary camera system is independent from the secondary camera system.

12. The method of claim 10, wherein the two or more cameras have a three hundred sixty degree view about the autonomous vehicle.

13. The method of claim 10, wherein each of the two or more cameras comprises a set of cameras.

14. The method of claim 10, wherein causing the video captured by the secondary camera system to be stored comprises not deleting a camera buffer.

15. The method of claim 10, wherein the trigger condition is an impact event.

16. The method of claim 10, wherein the causing the video captured by the secondary camera system to be stored comprises causing the secondary camera system to begin capturing the video.

17. The method of claim 10, wherein autonomous vehicle is an aerial vehicle, and wherein the trigger condition is a deviation from a flight plan.

18. The method of claim 10, wherein the vehicle body includes four arms, wherein the secondary camera system includes four cameras, and wherein each of the four arms includes one of the four cameras.
